(19) United States
(12) Patent Application Publication
(10) Pub. No.: US 2026/0090513 A1
(43) Pub. Date: Apr. 2, 2026

(54) METABOLIC CAGE COLLECTION ARRAY

(71) Applicant: VANDERBILT UNIVERSITY, Nashville, TN (US)

(72) Inventor: Craig Brooks, Nashville, TN (US)

(21) Appl. No.: 19/343,098

(22) Filed: Sep. 29, 2025

Related U.S. Application Data
(60) Provisional application No. 63/699,928, filed on Sep. 27, 2024.

(51) Int. Cl. A01K 1/03; A01K 1/01

(52) U.S. Cl. CPC A01K 1/031; A01K 1/01

(57) ABSTRACT

Various examples are provided related to metabolic cage collection arrays. In one example, a metabolic cage includes an enclosure; a collection array within the enclosure, the collection array including wells, each well including a funnel that can collect waste in a corresponding reservoir; a mesh filter disposed above the collection array, the mesh filter designed to prevent the waste of a particular type or larger than a defined size from being transported to the collection array; and a walking platform above the mesh filter, the walking platform including a gridded surface. The funnel of each well can transport waste passing through the gridded surface of the walking platform and the mesh filter to the corresponding reservoir.

### CROSS REFERENCE TO RELATED APPLICATIONS

This application claims priority to, and the benefit of, U.S. provisional application entitled “Metabolic Cage Collection Array” having Ser. No. 63/699,928, filed Sep. 27, 2024, which is hereby incorporated by reference in its entirety.

### BACKGROUND

Laboratory experiments often require animals for various reasons, including studying their habits, their nutrition intake, and their waste. Animals may be of various types and sizes and although this disclosure relates to rodents, it is also equally applicable to other rodents, such as rats, etc. The waste recovered from animals may often need a separation of solid waste (feces) from liquid waste (urine). The animals may also need to be kept in isolation from other animals and under specific habitat conditions. To accomplish housing animals, such as rodents, under certain conditions, the laboratory rodents and other animals are often moved to metabolic cages for observation. However, once moved, collecting samples, including urine and other biological material, can present a challenge as rodents and other animals are often stressed when they undergo relocation. Stress is an issue as it can affect the metabolism of the rodents and other animals and alter the results in downstream assays. Furthermore, stressed rodents and other animals may just not produce as much urine or other biological material to use as samples.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A and 1B are images presenting examples of metabolic cages as described in the present application.

FIGS. 2A and 2B are illustrations presenting examples of a metabolic cage without an outer enclosure as described in the present application.

FIG. 3 is an image presenting an example of a collection array as described in the present application.

FIG. 4 is an illustration presenting an example of a shape of reservoir wells included in the collection array as described in the present application.

FIG. 5 is an illustration presenting an example of a mesh filter to include in the metabolic cage as described in the present application.

FIG. 6 is an image presenting an example of a collection array covered by a mesh filter within a metabolic cage as described in the present application.

FIG. 7 is an illustration presenting an example of a food supply to position inside the metabolic cage as described in the present application.

FIG. 8 is an illustration presenting an example of a water dispenser to position inside the metabolic cage as described in the present application.

FIGS. 9A and 9B are illustrations presenting examples of components of a metabolic cage as described in the present application.

FIG. 10 is an illustration presenting an example of a metabolic cage including a means of weighing the rodent or other animal as described in the present application.

FIGS. 11A and 11B are illustrations presenting an example of an animal hut that can interlock with the walking platform of the metabolic cage as described in the present application.

FIGS. 12A and 12B are illustrations presenting an example of a container that can interlock with the walking platform of the metabolic cage as described in the present application.

FIG. 13 is an image presenting an example of an animal hut and a bowl that are interlocked with the walking platform as described in the present application.

FIG. 14 is an illustration presenting an example of a metabolic cage comprising an enrichment tool as described in the present application.

FIG. 15 is an illustration of a metabolic cage with a specific ventilation system that can be used to regulate intake and output of air as described in the present application.

### DETAILED DESCRIPTION

Before the present disclosure is described in greater detail, it is to be understood that this disclosure is not limited to any particular embodiment described herein. The embodiments presented herein are to be considered as non-limiting and non-exhaustive examples. It is also to be understood that the terminology used herein is for the purpose of describing particular embodiments only, and is not intended to be limiting, since the scope of the present disclosure will be limited only by the appended claims.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

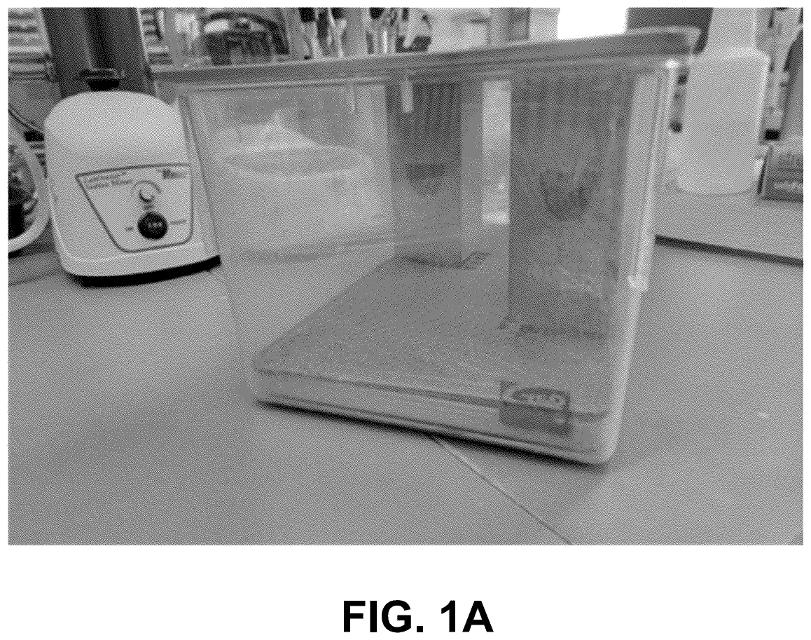

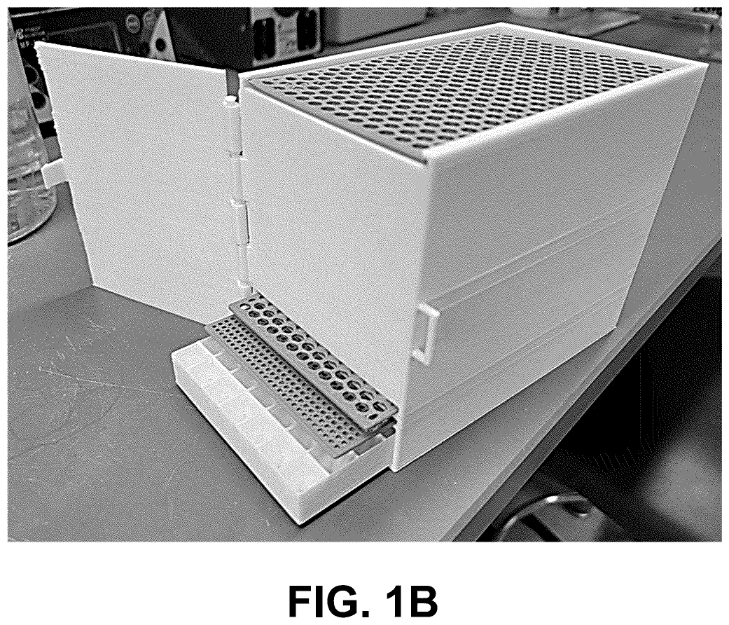

Referring to FIG. 1A, presented is an image of an example of a metabolic cage as described herein. The depicted metabolic cage is an enclosure that includes various components. In this example, the enclosure includes a collection array disposed at the bottom of the enclosure, a mesh filter (or feces screen) disposed above the collection array, a walking platform disposed above the mesh filter, and a cover of the enclosure. The metabolic cage of FIG. 1A also includes one or more nourishment insert extending from the cover to the collection array through one or more openings in the walking platform and mesh filter. The nourishment inserts can be far apart or close together, be facing in the same or different directions, be providing the same type of nourishment or different types, can be removable or permanently attached to the cover, and can be modified in various other ways. In FIG. 1A, the nourishment inserts extend to the collection array, both of them facing in the same direction. One of the nourishment inserts provides food, the other provides water to the animal inside the enclosure.

In FIG. 1A, the enclosure is plastic but can alternatively or in combination be made of wood, metal, or other materials. Materials with which the enclosure and/or components within can be crafted include, but are not limited to, plastic, glass, carbon-fiber reinforced plastics, resin-based materials, glass-reinforced nylon, etc. The enclosure and/or its components can be made of material that is temperature resistant to at least the point where the metabolic cage and/or its components allow for sterilization. Furthermore, the enclosure and its structural components can be formed or fabricated with rounded edges to discourage chewing.

The enclosure is transparent, making it possible to see inside and out. Alternatively, the enclosure could allow sight of what is within or without. Additionally, there could be parts or portions of the enclosure that allow one to see what is inside or what is outside the enclosure, whereas other parts or portions of the enclosure do not allow the same. The enclosure is sealed but could alternatively have one or more openings to allow for things (e.g., air, a hand, food, etc.) to be moved in or moved out of the enclosure without removing the cover.

In FIG. 1A, the enclosure displayed is large enough to house at least one rodent or another animal of equal size and used to similar living conditions. This example is non-limiting so the size of the enclosure can be larger or smaller, allowing the dimensions to be varied to whatever is suitable or optimal for the species being housed. Furthermore, although this disclosure refers and relates to rodents, it is also equally applicable to other types of animals. The metabolic cage and its components can be 3D printed or otherwise created to allow for accommodations of animals of various sizes. As a result, the metabolic cages are also relatively affordable when compared to others in the market. The enclosure can also be an existing cage or enclosure with components sized for use within the existing enclosure or can be sized for use in existing racks, which can provide significant cost savings and increase acceptance.

FIG. 1B illustrates another example of a metabolic cage as described herein. The depicted metabolic cage is an enclosure that includes a side access to various components within the enclosure. As in the example of FIG. 1A, the enclosure includes a collection array disposed at the bottom of the enclosure, a mesh filter (or feces screen) disposed above the collection array, and a walking platform disposed above the mesh filter. The enclosure of FIG. 1B includes a side that opens to allow access to the collection array, mesh filter and walking platform through one or more opening. As shown in FIG. 1B, the side includes a cover that can be secured in a closed position (using, e.g., a latch, clip, tab, hook or other appropriate locking or securing mechanism) to hold the components (e.g., collection array, mesh filter, walking platform, cover, etc.) in position in the enclosure and can be opened to access the components together or individually as illustrated. The cover can be a door or panel that can be detachably secured over the one or more openings. The enclosure can include openings and guide rails to facilitate removal and insertion of one or more of the components. The collection array can be removed and replaced without disturbing the rodent or other animal within the enclosure. Samples can be collected from the collection array without removing the cover over the enclosure. While FIG. 1B shows a standalone design for a single enclosure, the design can also be utilized for a rack of enclosures. The size and shape of the metabolic cage may be varied to fit existing animal care racks.

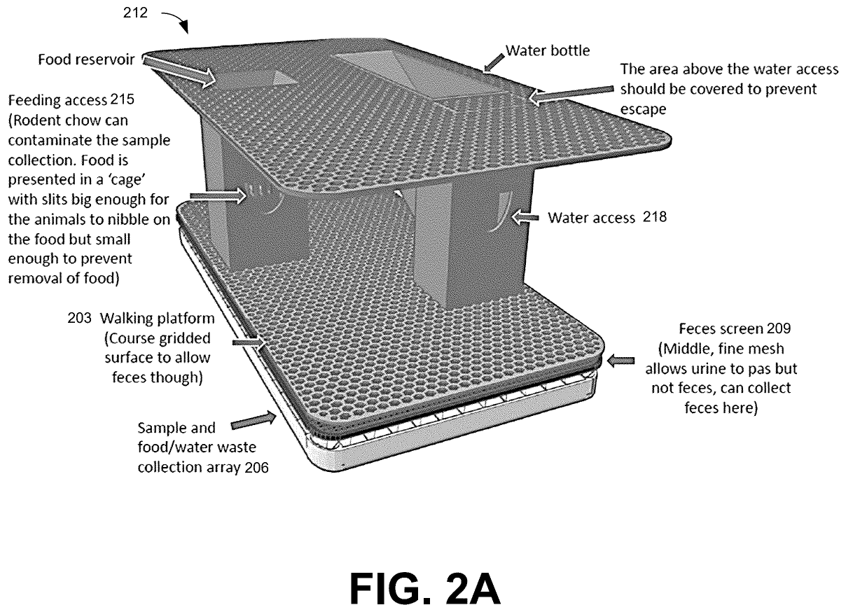

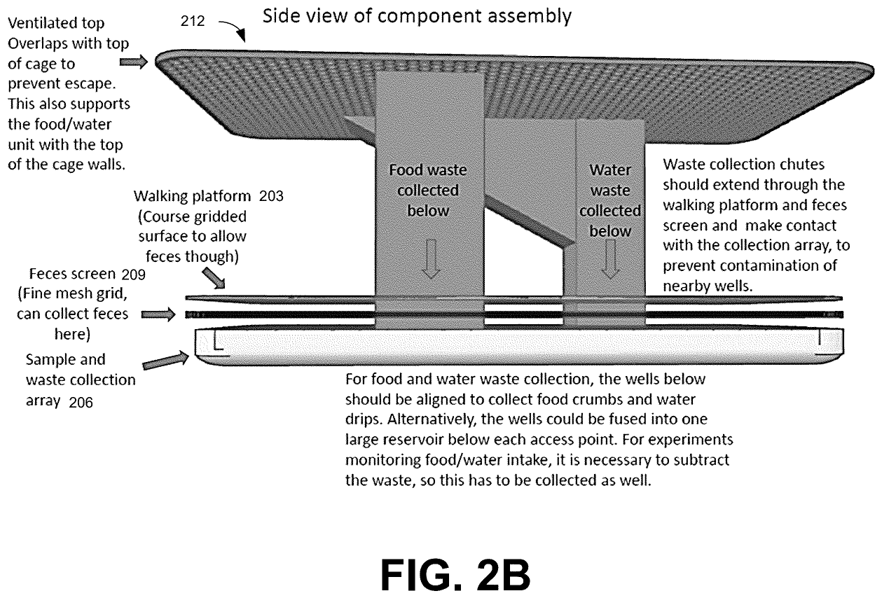

FIGS. 2A and 2B are illustrations that present examples of the metabolic cage described herein from different angles. The components mentioned above are presented without the outer enclosure in FIGS. 2A and 2B to illustrate the component arrangement from different perspectives. FIGS. 2A and 2B serve to show that the metabolic cage described in this disclosure is a modular device where certain components can be present while others are absent, the sizes can be altered, the functionality can be adjusted, etc. Furthermore, components including the walking platform 203, the collection array 206, and the mesh filter (feces screen) 209, can have clips attached to them to facilitate removal and replacement of the components. For example, a researcher could remove the walking platform 203 and have direct access to the reservoir wells in the collection array 206 underneath.

The metabolic cage, as described in this disclosure as a non-limiting example, can have a walking platform 203 that allows waste to move through a gridded surface on the walking platform 203. The openings through the walking platform 203 can be tapered to cause movement of waste in a particular direction through the gridded surface on the walking platform 203. Furthermore, the metabolic cage can include one or more nourishment inserts 212. For example, in FIGS. 2A and 2B, one of the nourishment inserts comprises a food supply (e.g., a package of rodent food, a medicine container, etc.) that is configured such that it requires the rodent to reach through the structure for access to the food instead of providing easy access to the food. The food supply comprises a walled off area with a feeding access 215 having an opening large enough to exclusively allow for food to be eaten through one side of the structure. The feeding access can be located at a midpoint of the side, requiring that the animal climb up through the opening for access.

In FIGS. 2A and 2B, the metabolic cage can comprise a second nourishment insert that can be identical to the first nourishment insert, similarly shaped, or a different shape. For example, as can be seen in a comparison of FIG. 2A to FIG. 2B, the first nourishment insert can have a shape and structure that is straight, where nourishment or anything else can be put at the top and move straight down to the be accessible by the rodent or other animal. Alternatively, the second nourishment insert can be shaped to comprise a ramp, where a bottle with a sipper tube or dispenser can be faced into the ramp, and only the sipper tube or dispenser becomes accessible to the rodent or other animal. The angle of the ramp can be in, e.g., a range from about 20 degrees to about 45 degrees. Each nourishment insert can be shaped permanently this way or have an adjustable shape so as to allow further customization. In the example of FIGS. 2A and 2B, the second nourishment insert is different from the first nourishment insert in that the second nourishment insert is one that provides the rodent or other animal with access to liquids, with the second nourishment insert giving access to a liquid sipper tube or dispenser that is connected to a liquid source (e.g., a water bottle, a medicine bottle, etc.) in a walled off region of the second nourishment insert. In FIGS. 2A and 2B, the water sipper tube or dispenser can be accessible only through a water access 218 having an opening on, e.g., the same side as the opening of the first nourishment insert and also only through an intended reach.

Each nourishment insert can have one or more openings to access the nourishment provided. Each nourishment insert can provide one or more types of nourishment. The nourishment inserts are configured, using at least in part the walled off openings, to prevent the rodent or other animal from escaping the enclosure through the nourishment insert. Excess nourishment waste (e.g., an overflow of food and/or water or spillage produced during feeding) can be collected through waste collection chutes that extend through openings in the gridded surface on the floor of the walking platform 203 and/or the mesh filter 209 that are in alignment to receive excess materials from the nourishment inserts. The excess nourishment waste is deposited in the collection array 206.

The collection array 206 can comprise a plurality of reservoir wells to collect the waste moving through the gridded surface of the walking platform 203 and the mesh filter 209. The waste can be transported to the plurality of reservoir wells in ways including moving through a plurality of funnels extending below the gridded surface and the collection array. The reservoir wells in which the excess nourishment is collected can be different from the wells in which waste from the walking platform is collected. In addition, or alternatively, the reservoir wells can be configured with a single reservoir below the waste collection chute of each nourishment insert. Alternatively, the collection array 206 can also include one or more reservoir well which collects excess nourishment and waste from the walking platform 203. The gridded surface can be structured in such a way that each funnel of the plurality of funnels separately receives the waste from a different or the same region of the gridded surface.

The enclosure can include a mesh filter (or feces screen) 209 to prevent waste of a particular type or size from being collected in the plurality of reservoirs of the collection array 206, the mesh filter 209 being positioned between the gridded surface of the walking platform 203 and the plurality of reservoirs of the collection array 206. This mesh filter 209 can serve as a feces screen and therefore allow for separate collection of liquid waste, including urine, from solid waste, including feces. The plurality of funnels, a plurality of waste collection chutes, or some other similar structure can be employed to passively or actively transport waste from the walking platform 203 to the collection array 206. In some examples, a sample of waste can travel through the gridded surface and into a funnel through the mesh filter 209 where it is directed into a reservoir well included in the collection array 206.

The enclosure can include a ventilation top that can overlap the top of the enclosure and thereby prevent escape of the rodent or animal. Furthermore, the ventilation top can provide for air to flow in and out of the enclosure. A cover including a fine filter can be located on top of the ventilation top for air filtration and/or to prevent debris and/or biological contaminants from entering the enclosure. The ventilation top can also steady one or more nourishment inserts 212 by providing another structure to support the cover of the enclosure from which the nourishment inserts 212 extend to walking platform 203 or the collection array 206.

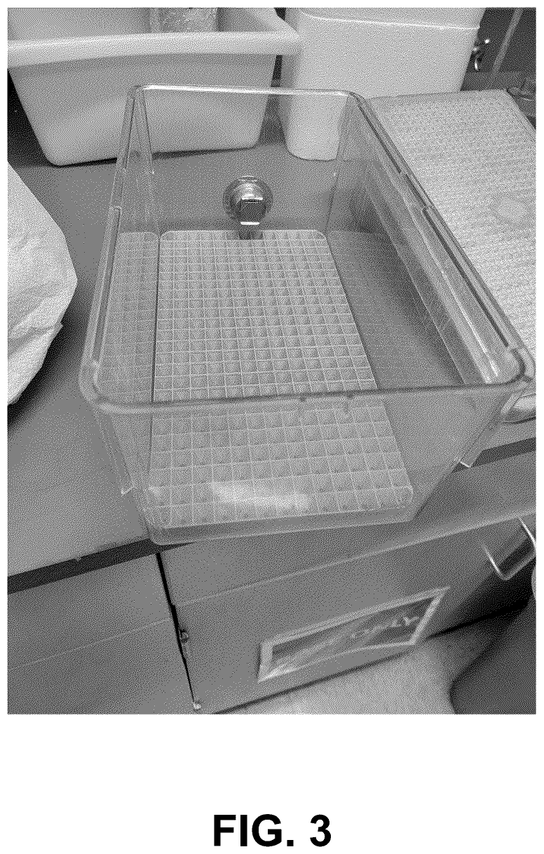

FIG. 3 is an image presenting an example of a collection array 206. As discussed above, the collection array 206 can be placed underneath the walking platform 203 and mesh filter 209 within the metabolic cage and used to collect urine or other samples. The collection array can be sized to fit into standard housing cages. The collection array 206 can vary in height, length and width to satisfy the application needs; for example, the collection array in FIG. 3 is approximately 1.5 cm high and sized to fit in the bottom of an enclosure (e.g., a standard housing cage). The collection array 206 can comprise an array of reservoir wells covering a portion, including the whole surface, of the collection array. As mentioned above, the collection array 206 can be associated with a tab or another structure that facilitates removing the collection array from the enclosure. The collection array 206 allows for samples deposited at the level of the walking platform 203 to be collected in separate reservoir wells after being transported through the mesh filter 209.

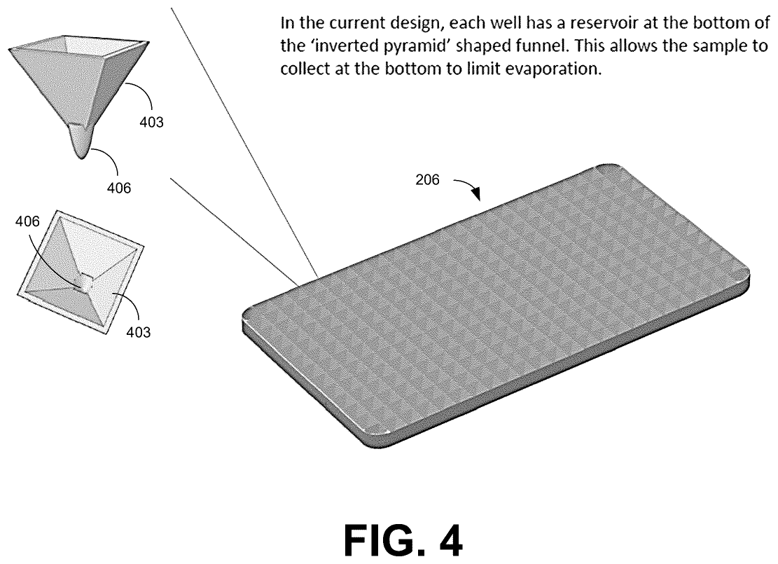

FIG. 4 is an illustration presenting an example of a shape of reservoir wells included in the collection array 206. As illustrated in the top and side views of FIG. 4, a well includes a funnel 403 that collects waste in a corresponding reservoir 406. In FIG. 4, the reservoir wells are shown as being square-shaped at the top, with the funnel 403 thinning down to the reservoir 406 at the bottom. Alternatively, it could be stated that the funnels 403 of the reservoir wells are shaped as inverted pyramids. As another alternative, the reservoirs 406 of the reservoir wells can be termed to be bullet shaped. The shape of the reservoir 406 aids in sample retrieval, making it easier to remove all of the sample from the reservoir well. The height of the reservoir well can be adjusted to provide a desired volume to accommodate different species (e.g., rats, mice, etc.) or disease models, e.g., with polyuria (e.g., diabetes) that generates more urine. The reservoir wells can be in the form of other shapes as well. For example, the reservoir wells can be circular, cylindrical, rectangular, etc. The wells in the corners of the collection array 206 have a modified shape (part square and part circular) to account for the rounding of the enclosure walls. The reservoir wells allow for a decrease in a rate of evaporation by collecting liquid samples and pooling them together in the reservoir 406. The reservoir wells can also be treated with wax or other hydrophobic material to aid in the collection of samples at the center of the well.

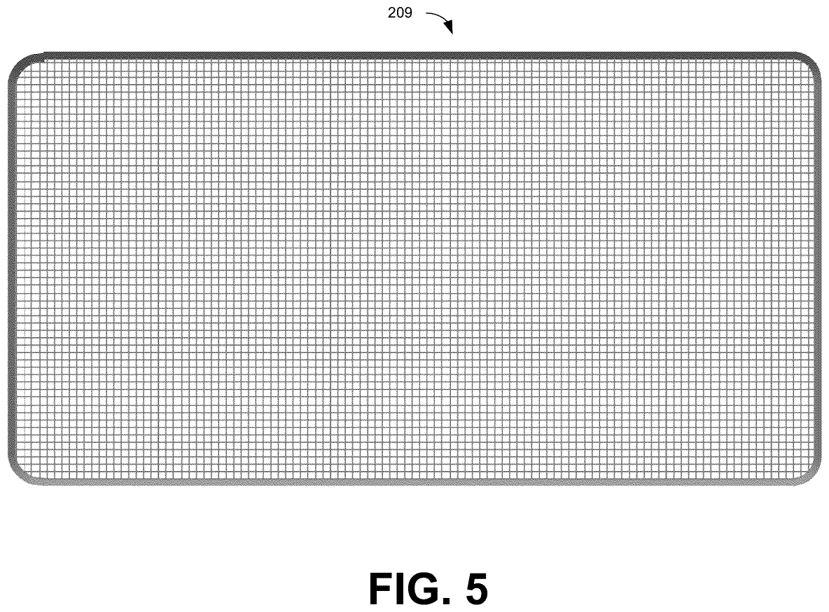

FIG. 5 is an illustration presenting an example of a mesh filter 209 to include in the metabolic cage as described in the present application. The mesh filter 209 can be placed on top of the collection array 206, allowing samples collected on the walking platform to pass through the grid into funnels 403 of the reservoir wells of the collection array 206. The mesh filter 209 can prevent fecal contamination of the urine samples and allow for fecal collection on the mesh filter 209. The mesh filter 209 can comprise a wire or plastic grid with openings sized to be large enough to allow urine to pass through but small enough to prevent fecal matter to pass (e.g., about 1 mm²). The mesh filter 209 can have a raised border so there is separation between the grid of the mesh filter 209 and the gridded surface of the walking platform 203. By having the mesh filter 209 separated from the walking platform 203, it is possible to avoid contamination of the collected samples by feces. The separation provided by the elevated walking platform 203 prevents feces from being pushed through the mesh filter 209 when stepped on by the rodent or other animal. The grid structure and spacing of the walking platform 203 can be designed to facilitate passage of the feces to the mesh filter 206 while maintaining comfort of the rodent or other animal. The border can be wedge-shaped so the collection array 206 and/or the walking platform 203 can interlock with the mesh filter 209. The mesh filter 209 can be slightly longer and wider than the collection array 206 so as to fit on top and fill any gaps. This is partially to attend to the fact that laboratory cages, including metabolic cages, are often wider at the top than bottom. In some examples, the mesh filter 209 can be structured to be hydrophobic and thereby reduce the amount of excess water present on it.

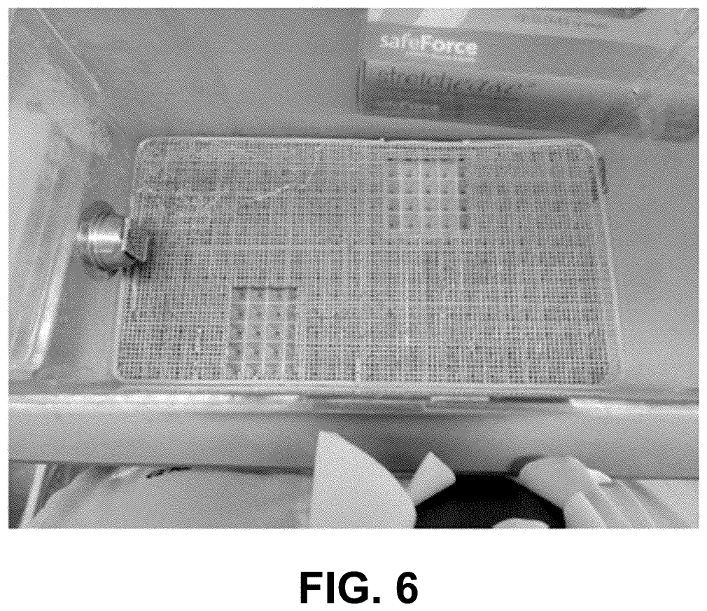

FIG. 6 is an image presenting an example of a collection array 206 covered by a mesh filter 209 within a metabolic cage. In FIG. 6, the mesh filter 209 can be seen interlocked with the collection array 206, thereby preventing movement of one without the other. Furthermore, FIG. 6 displays how the mesh filter 209 covers the entirety of the collection array 206, thereby allowing for only acceptable waste to be transported to the reservoir wells of the collection array 206. Furthermore, the open portions of the mesh filter 209 through which the reservoir wells can be seen are covered in practice by waste collection chutes of either the food supply or the water dispenser.

The walking platform 203 can be adapted to fit a wide variety of cages and needs of multiple research studies. As illustrated in FIG. 2A, the walking platform 203 can include hexagonal shaped openings with, e.g., a 5 mm opening, 1 mm side, and a 0.5 mm platform thickness dimension. In some examples, the walking platform openings can be of a different shape such as, but not limited to, a square, a rectangle, a circle, a sphere, etc. and can have an opening about 15 mm or less, or in a range from about 1 mm to about 10 mm. The opening and the side dimension of each grid and the shape of the whole walking platform 203 can be changed to better suit the needs the application. The separation between the walking platform 203 and mesh filter 209 can also be varied to avoid contamination as previously discussed depending upon the application. In some implementations, the walking platform 203 can be configured to house multiple animals. For instance, a divider can be used to form at least one vertical wall on the walking platform, thereby forming separate housing compartments for two or more rodents or other animals. In this scenario, each separate housing compartment for each of the animals can also have its own nourishment inserts.

As discussed with respect to FIGS. 2A and 2B, extending from the food and water access areas (e.g., nourishment inserts) are chutes that direct any food and/or water waste to the reservoir wells in the collection array 206 below the waste collection chutes. Cutouts are made in the walking platform 203 and mesh filter (e.g., feces screen) 209 to allow the chutes to pass through and make contact with the collection array 206. This allows for collection of food waste in a controlled area, and prevents spillage of the food crumbs and/or water drops onto waste samples being collected outside the waste collection chute. The collection array 206 can also be modified with large wells aligned below the food/water waste chutes. Food and/or water waste can be collected to get an accurate readout of the amount consumed (e.g., original amount minus (final amount+waste)) by the rodent or other animal. The waste collection chute and collection array 206 could also be configured to interconnect to ensure no spillage. As mentioned above, food crumbs and water drops are collected through these openings to avoid food crumbs and/or water drops entering into reservoir wells where waste samples (e.g., urine samples) are collected.

Additionally, for the one or more nourishment inserts 212, the top of each is ventilated and extends to overlap with the top of the enclosure walls by being associated with the cover. This can prevent escape of the rodent or other animal through or because of the nourishment inserts. Being associated with the cover and having support of the enclosure walls also serves to support the nourishment inserts against applied force by the rodent or other animal when applied. While a majority of rodent and other animal cages have ventilated covers with fine filters to prevent contamination through the air, this design does not interfere with the cage cover. The filtered cover is an additional lid that fits over the ventilated top and prevents escape of the rodent or other animal, otherwise it could chew on the filter. The filtered cover can be separated from the ventilated by a distance of, e.g., about 2 cm. Accordingly, the filtered metabolic cage cover can be used without concern of air contamination through the tops of the nourishment inserts. Furthermore, the food supply and the water dispenser could be made airtight and fitted with a predefined amount of air and/or an air analyzer to monitor the respiration. For multiple housing units, as described above in relation to a divider being used, the nourishment inserts could be divided as well and thereby allow for nourishment to a plurality of sides of the food supply and the water dispenser. Thus, this system therefore allows researchers to monitor food and water intake, collect waste food and water, and to collect urine and feces without needing to relocate the rodent or other animal.

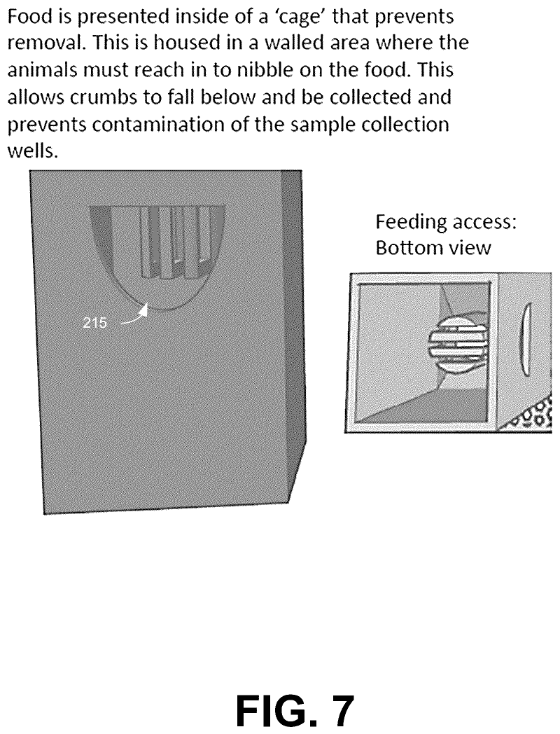

FIG. 7 is an illustration presenting an example of a food supply within a waste collection chute to position inside the metabolic cage as described in the present application. FIG. 7 illustrates the food supply from multiple perspectives, e.g., facing the food supply through a feeding access opening 215, and from below the food supply. As show in FIG. 7, the food supply involves presentation of food for the rodent or other animal in such a manner that prevents removal of the uneaten food. To gain access to the food to eat, the rodent or other animal must reach into a walled area of the chute through the feeding access opening 215 and nibble on the food inside the cage. The cage structure for the food is spaced to allow the rodent or other animal to access the food for consumption with their mouth but prevent its removal from the cage for consumption elsewhere. Having the openings extend across the bottom of the cage structure allows for food crumbs and other uneaten waste to fall through the walking platform 203 and be collected by either a mesh filter 209 or by being deposited into one or more specific reservoir wells of the collection array 206. Appropriate sizing and positioning of the access opening on the side of the chute can allow the rodent or other animal to access the food while making it difficult to grasp the food for removal. The cage structure also prevents the rodent or other animal from escaping through the waste collection chute.

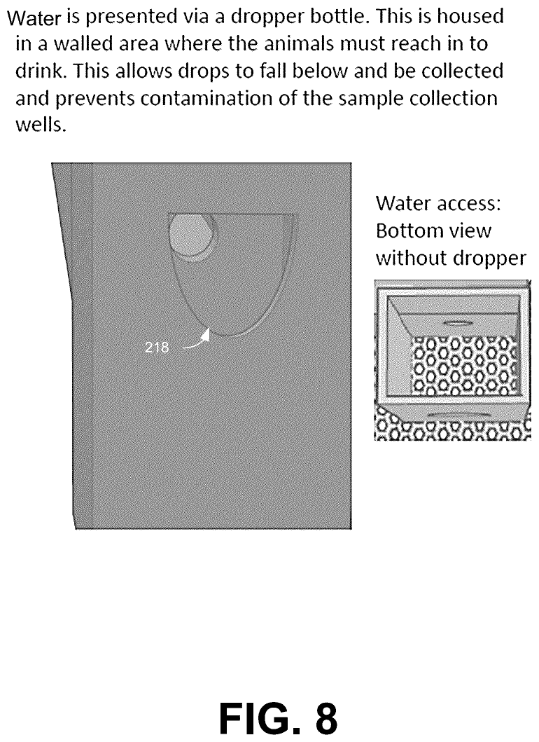

FIG. 8 is an illustration presenting an example of a water dispenser within a waste collection chute to position inside the metabolic cage. FIG. 8 illustrates the water dispenser through a water access opening 218 and from below. The water dispenser is contained in a walled area as shown in FIG. 2A, with the sipper tube or dispenser recessed within an opening of the walled area of the waste collection chute. This results in the rodent or other animal needing to reach through the water access opening 218 inside the chute to drink. This results in excess water drops falling into reservoir wells for collection of excess water in the collection array 206. A cover can be included over the top of the waste collection chute to prevent escape of the rodent or other animal as shown in FIG. 2A.

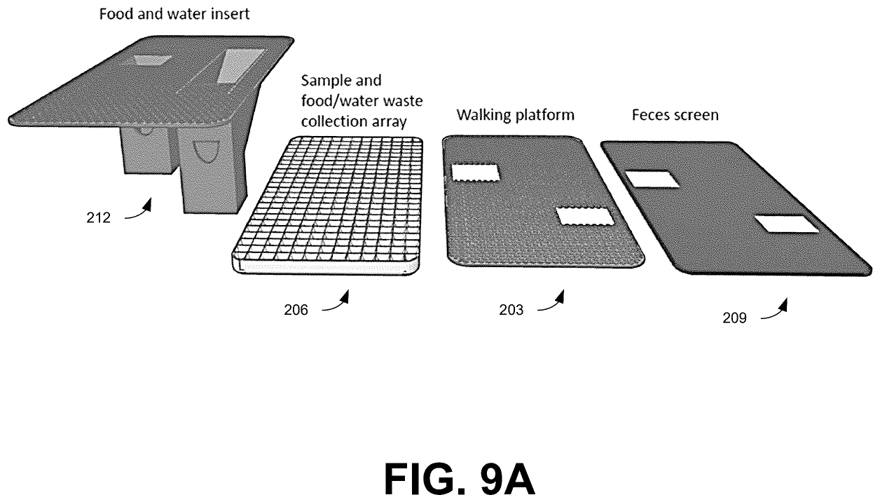

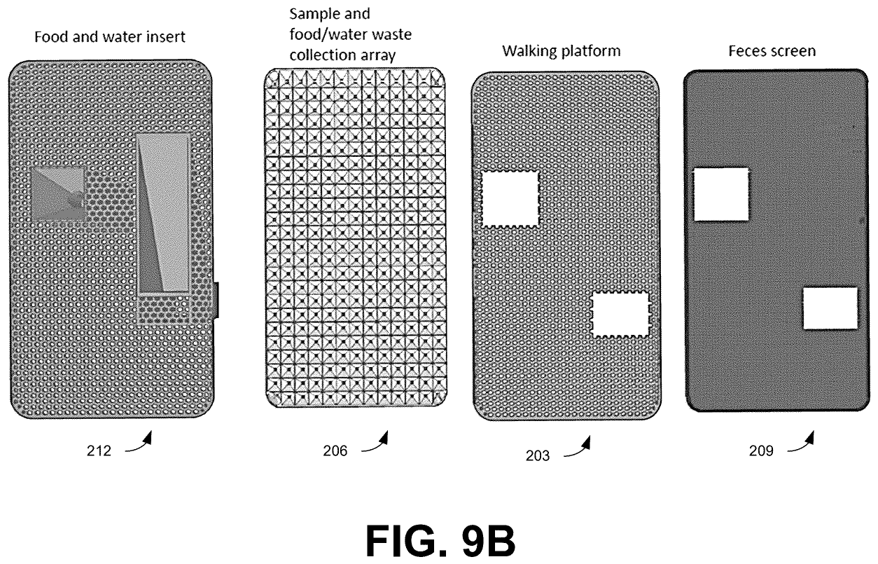

FIGS. 9A and 9B are illustrations presenting examples of components of a metabolic cage separated from each other. FIG. 9A shows the components at a flat angle And FIG. 9B shows the components from the top-down. The different components can be structured together in different ways. For example, the walking platform 203 could be clipped into the enclosure and can be pulled out by pulling a clip or tab. The cover of the enclosure, along with the nourishment inserts 212, can be placed on top of the walking platform 203 when the walking platform 203 is clipped in. The collection array 206 can be placed on the bottom of the enclosure with the mesh filter 209 placed on top of the collection array 206. The walking platform 203 can be placed on top of the mesh filter 209 and the collection array 206 when placed into the enclosure or when clipped in. The spacing of the separation between the walking platform 203 and the mesh filter 209 can be adjusted to account for different size solid waste from different rodents or other animals. The collection array 206 could also be interlocked with the mesh filter 209 and/or the walking platform 203. The mesh filter 209 could be interlocked with the collection array 206 and/or the walking platform 203. The walking platform 203 could be interlocked with the nourishment inserts 212 to provide stability and support. Components shown in FIGS. 9A and 9B are the nourishment insert (e.g., food and water insert) 212, a collection array 206 including the plurality of reservoir wells, a walking platform 203, and a mesh filter (e.g., feces screen) 209. The collection array 206 can include clips or tabs to assist in its removal by pulling on them, without disrupting or spilling the samples.

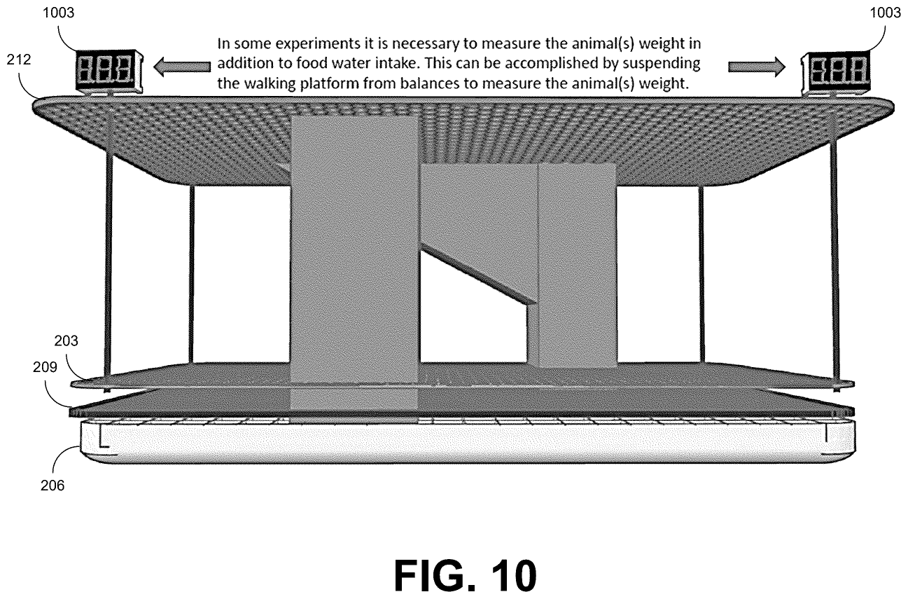

FIG. 10 is an illustration presenting an example of a metabolic cage including a means of weighing the rodent or other animal. When research is being performed, it is often found beneficial to keep track of rodent or other animal mass. Accordingly, the rodent or other animal may at least periodically be weighed. FIG. 10 displays an example process of doing so. As can be seen, the walking platform 203 can be suspended from one or more balances 1003 residing above the cover of the nourishment insert 212. The walking platform 203 can be suspended by rods, struts, cables, or other appropriate supports having material (e.g., metal or glass) that would resist damage by the rodent or other animal. The suspension of the walking platform 203 can result in a measurement of the weight of the rodent or other animal. The measured weight can be observed and captured digitally directly through a computing device communicatively coupled to the balances 1003. In some cases, the balances 1003 can be used to monitor activity of the animal by sensing variations in load carried by the balances 1003 attached to different corners of the walking platform 203.

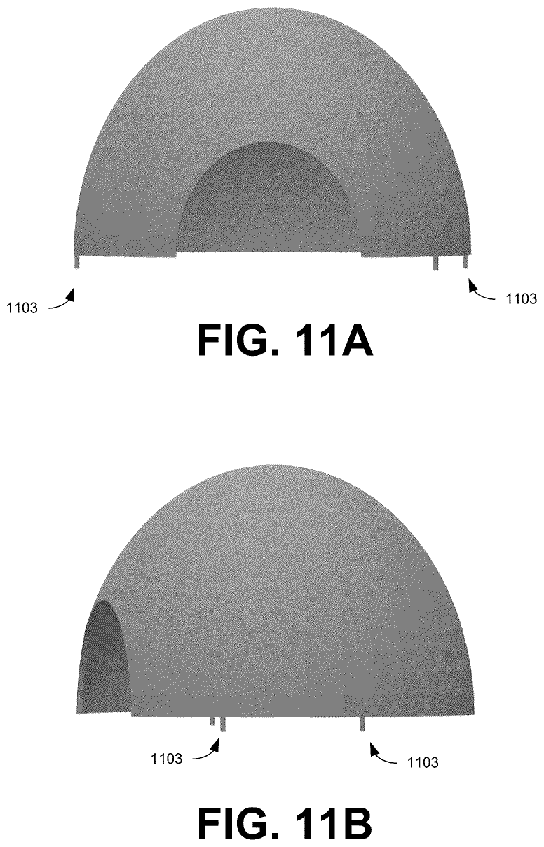

FIGS. 11A and 11B are illustrations presenting an example of an animal hut that can interlock with the walking platform 203 of the metabolic cage as described in the present application. Laboratory studies often result in rodents or other animals being stressed, tired, curious, etc. Accordingly, to better accommodate a rodent or other animal, an animal hut can be provided to the rodent or other animal inside the enclosure. This animal hut can allow the rodent or other animal to have somewhere to retreat to when fatigued, stressed, or scared. This animal hut can provide the rodent or other animal with a sense of security and protection, thereby reducing stress. The animal hut shown in FIGS. 11A and 11B includes feet 1103 that can interlock with the walking platform 203 and thereby prevent movement of the animal hut. The feet 1103 can include fasteners such as, e.g., pegs, hooks, tabs, etc. that can interlock with the walking platform 203. Front and side views of the animal hut with respect to the opening are provided in FIGS. 11A and 11B.

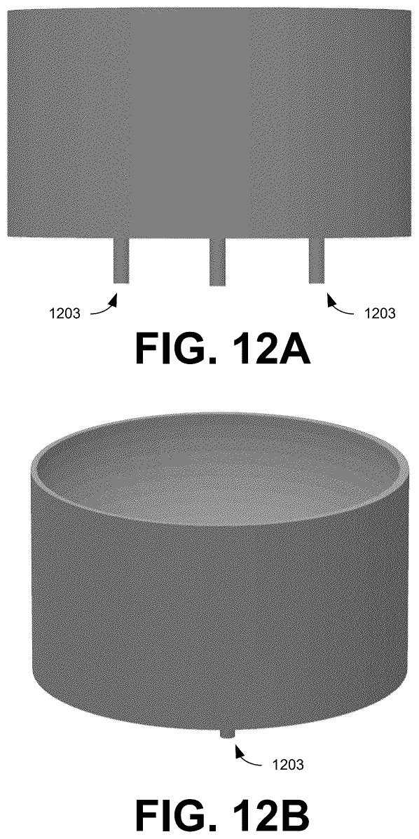

FIGS. 12A and 12B are illustrations presenting an example of a container that can interlock with the walking platform 203 of the metabolic cage as described in the present application. In FIGS. 12A and 12B, the container shown resembles a bowl. This is only to serve as a non-limiting example and the container could instead be of a different shape and/or size. A reason for the container can be that for a rodent or other animal who does not agree with food provided through the food supply, or in a metabolic cage in which there is no food supply, alternative forms of nourishment can be provided by being placed in the container. For example, a rodent or another animal can be provided with a gel diet that is presented by being placed in the container. FIGS. 12A and 12B show multiple views of the container with feet 1203 that can interlock with the walking platform 203 and thereby prevent movement. The feet 1203 can include fasteners such as, e.g., pegs, hooks, tabs, etc. that can interlock with the walking platform 203. Structures such as the animal hut of FIGS. 11A and 11B and the container of FIGS. 12A and 12B are intended as non-limiting and non-exhaustive examples. The rodent or other animal can receive structures in other shapes and forms for various reasons.

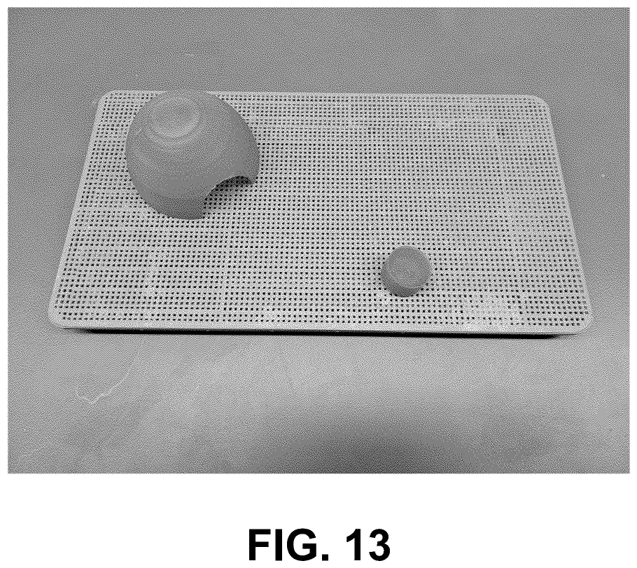

FIG. 13 is an image presenting an example of an animal hut and a bowl that are interlocked with the walking platform 203 as described in the present application. FIG. 13 is useful as it displays how the animal hut and the container would look when interlocked with the walking platform 203. The size and shape of each, the animal hut, the container, and the walking platform 203 can be adjusted.

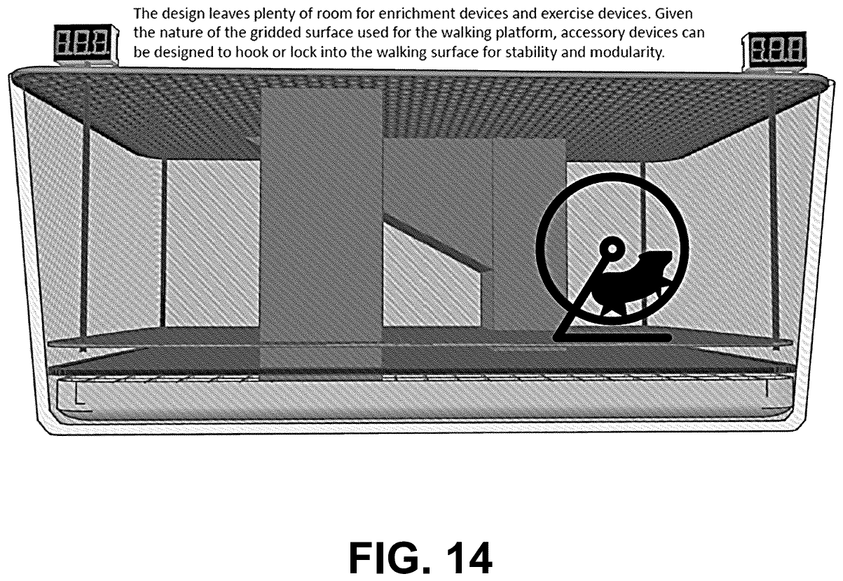

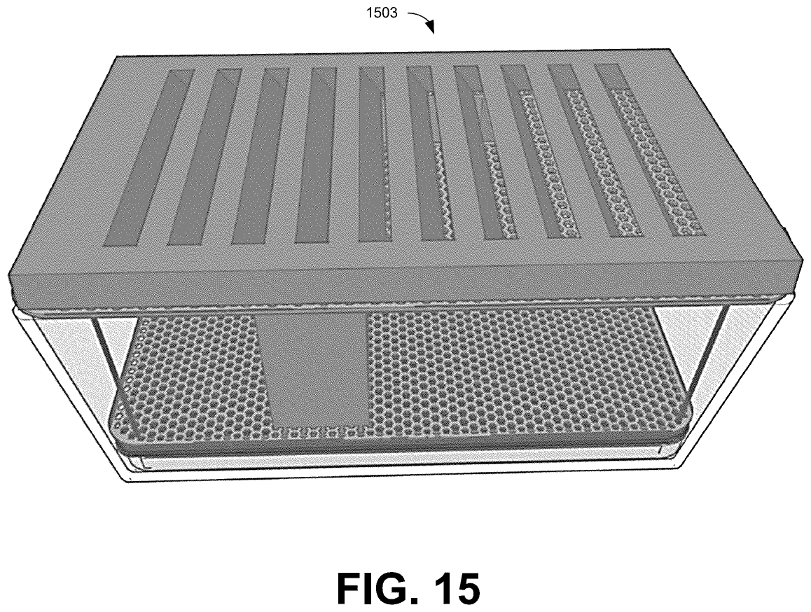

FIG. 14 is an illustration presenting an example of a metabolic cage comprising an enrichment tool as described in the present application. Laboratory studies often require rodents or other animals to be physically active at least a part of the time. Furthermore, rodents or other animals may often, without being pushed to do so, desire to be physically active themselves. FIG. 14 displays an enrichment tool that allows for a rodent or other animal to be physically active. Such enrichment devices and activities have been shown to improve study results by improving animal welfare. In FIG. 14, a wheel is shown in which a rodent or another animal can move as they see fit. This can be used to address the issue that the enclosure is limited in size and capacity and therefore might not allow for the rodent or other animal to get enough physical movement. An exercise wheel, as shown as a non-limiting example in FIG. 14, can address that issue. Other enrichment tools could be used either in addition to or instead of the exercise wheel shown in FIG. 14. For example, the rodent or other animal could be provided with a ball, a swing, a puzzle, etc.

FIG. 15 is an illustration of a metabolic cage with a specific ventilation system that can be used to regulate intake and output of air as described in the present application. Research studies often require measurement and analysis of the respiration of a rodent or another animal. Research studies may also require the rodent or other animal to only receive a certain amount of air or a certain kind of air. To accomplish this, FIG. 15 displays a ventilated enclosure cover 1503. As mentioned above, this ventilated enclosure cover 1503 can have fine filters which allow only certain gases to move one way or the other. The filtered cover 1503 can prevent bacteria, parasites and/or other pathogens from entering the enclosure and infecting the rodent or other animal. In other embodiments, the cover 1503 can be made airtight to seal the enclosure with the only air for the rodent or other animal to breathe being provided by researchers through inserts, tubing, vents, etc., that pass through this cover 1503. The air can be pumped in under controlled conditions with, e.g., oxygen, CO₂, etc. levels being carefully controlled. The outflow can be monitored and compared to the inflow to measure the animal's respiration. In some implementations, the inflow can be controlled in response to the comparison and/or monitored outflow. Accordingly, the enclosure cover 1503 displayed in FIG. 15 is non-limiting and can instead be adjusted in size, shape, and functionality to meet the needs of the researchers.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

Therefore, the following is claimed:

1. A metabolic cage, comprising:
an enclosure;
a collection array disposed within the enclosure, the collection array comprising a plurality of wells, each well comprising a funnel configured to collect waste in a corresponding reservoir;
a mesh filter disposed above the collection array, the mesh filter designed to prevent the waste of a particular type or larger than a defined size from being transported to the collection array; and
a walking platform disposed above the mesh filter, the walking platform comprising a gridded surface;
wherein the funnel of each well is configured to transport waste passing through the gridded surface of the walking platform and the mesh filter to the corresponding reservoir.

2. The metabolic cage of claim 1, comprising at least one nourishment insert comprising a waste collection chute extending through a corresponding opening in the walking platform.

3. The metabolic cage of claim 2, wherein the at least one nourishment insert comprises a cover recessed within a walled area of the enclosure.

4. The metabolic cage of claim 1, wherein each funnel separately receives the waste from at least one grid of the gridded surface.

5. The metabolic cage of claim 1, further comprising determining a weight of the rodent via suspension of the walking platform from balances.

6. The metabolic cage of claim 1, further comprising an enrichment tool including a wheel, a ball, a swing, or a puzzle.

7. The metabolic cage of claim 1, further comprising at least one structure with feet that allows interlocking with the walking platform.

8. The metabolic cage of claim 1, wherein each corresponding reservoir of the plurality of wells is bullet-shaped to allow for a decreased rate of evaporation.

9. The metabolic cage of claim 1, further comprising a cover having a ventilation structure on the cover to allow for a predefined amount of air supply within the metabolic cage.

10. The metabolic cage of claim 1, further comprising a filtered cover to limit air contamination.

11. The metabolic cage of claim 1, further comprising a digital air sensor positioned within the metabolic cage to capture details associated with animal respiration.

12. The metabolic cage of claim 1, wherein each grid of the gridded surface has an opening in a range from about 1 mm to about 10 mm.

13. The metabolic cage of claim 1, wherein the gridded surface is hexagonal shaped.

14. The metabolic cage of claim 1, wherein openings of the walking platform are tapered to cause waste to move through the gridded surface.

15. The metabolic cage of claim 1, wherein the walking platform can be pulled out of the metabolic cage via an associated clip.

16. The metabolic cage of claim 1, wherein the metabolic cage and its structural components are configured with rounded edges to inhibit chewing.

17. The metabolic cage of claim 1, wherein the metabolic cage and included components are temperature resistant to allow for sterilization.

18. The metabolic cage of claim 1, wherein the walking platform, the mesh filter, the collection array, or a combination thereof is hydrophobic.

19. The metabolic cage of claim 1, wherein the metabolic cage is fabricated from glass-reinforced nylon.

20. The metabolic cage of claim 1, wherein the enclosure comprises a side opening configured for removable insertion of the collection array into the enclosure and a cover configured to be detachably secured over the side opening.
